(19) United States
(12) Patent Application Publication
(10) Pub. No.: US 2015/0154713 A1
(43) Pub. Date: Jun. 4, 2015

(54) CLAIM WORK ASSIGNMENT USING WEIGHTED WORKLOADS

(71) Applicant: Guidewire Software, Inc., Foster City, CA (US)

(72) Inventors: Luis Arturo Diaz, Redwood City, CA (US); Scott Robert Plummer, Lakeway, TX (US); Mui Thu Tran, San Carlos, CA (US); Patrick Kwoon Yuet Young, San Bruno, CA (US); Edward Anthony Wells, Miami Beach, FL (US)

(73) Assignee: Guidewire Software, Inc., Foster City, CA (US)

(21) Appl. No.: 14/159,324

(22) Filed: Jan. 20, 2014

Related U.S. Application Data
(60) Provisional application No. 61/911,951, filed on Dec. 4, 2013.

(51) Int. Cl. G06Q 40/08

(52) U.S. Cl. CPC G06Q 40/08

(57) ABSTRACT

Automated assignment of insurance claim work includes: obtaining an insurance claim work unit; identifying among a plurality of users of the insurance claims processing platform a set of eligible users who are eligible to process the insurance claim work unit; and automatically selecting among the set of eligible users a selected user to process the insurance claim work unit, including determining a set of weighted workloads that corresponds to the set of eligible users and applying a set of one or more assignment rules based on the set of weighted workloads.

### CROSS REFERENCE TO OTHER APPLICATIONS

This application claims priority to U.S. Provisional Patent Application No. 61/911,951 entitled CLAIM WORK ASSIGNMENT USING WEIGHTED WORKLOADS filed Dec. 4, 2013 which is incorporated herein by reference for all purposes.

### BACKGROUND OF THE INVENTION

Insurance companies underwrite insurance policies. When a certain event covered by the policy (e.g., an accident resulting in damages to the insured property) happens, the insurance policy holder will make a claim on the policy. Insurance companies often employ many claim adjusters to process claims. Typically, a manager assigns claims to individual claim adjusters. In a company with many adjusters, it can be difficult for the manager to keep track of who is working on what and know how to fairly assign work. Some existing claim processing software also provides simple automated techniques to assign work (e.g., according to a pre-arranged order in a round-robin fashion so that each adjuster will get approximately the same number of claims.) However, both the manual and the simple automated assignment processes can easily cause individuals to be underloaded or overloaded. For example, automobile policy claims involving injuries can be far more complex than claims only involving property damage; thus, if adjusters are assigned the same number of claims, the person handling multiple injury-related claims can be overloaded while another person handling the same number of non-injury-related claims can be underloaded.

### BRIEF DESCRIPTION OF THE DRAWINGS

Various embodiments of the invention are disclosed in the following detailed description and the accompanying drawings.

FIG. 1 is a functional diagram illustrating an embodiment of a programmed computer system for performing dynamic workload assignments in accordance with some embodiments.

FIG. 2 is a functional diagram illustrating an embodiment of data structures and processing components of a dynamic insurance claim work unit assignment system.

FIG. 3 is a flowchart illustrating an embodiment of a process for configuring the weighted workload classification criteria.

FIG. 4 is an embodiment of a classification configuration user interface screen used to configure a set of weighted workload classification criteria of a specific type of insurance claim work unit.

FIG. 5 is an embodiment of a user interface screen illustrating a list of the classification criteria sets.

FIG. 6 is a flowchart illustrating an embodiment of a process for computing an insurance claim work unit's weighted workload.

FIG. 7 is an embodiment of a user interface illustrating a table of insurance claim work units (assignables) and their respective weights.

FIG. 8 is a flowchart illustrating an embodiment of a process for dynamically assigning an insurance claim work unit.

FIG. 9 is a data structure diagram illustrating an embodiment of an organizational hierarchy.

FIG. 10 is a flowchart illustrating an embodiment of an update process.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Assigning insurance claim-related work on an insurance claims processing platform is disclosed. Users (e.g., claim adjusters) eligible to process an insurance claim work unit are identified. The weighted workloads of the eligible users are computed. A specific user is selected to handle the insurance claim work unit, where the selection is based at least in part on the weighted workloads.

As used herein, an insurance claim work unit refers to a unit of claim-related work that can be assigned to a user to be processed. Sometimes an insurance claim work unit is also referred to as an assignable. Examples of an insurance claim work unit include a claim, an exposure within a claim, an activity, a legal matter, a customer-configured new entity, etc. In some embodiments, an insurance claim work unit is implemented as an object, and its associated functions are implemented as methods of the object. A weighted workload (also referred to as workload weight) is a value that measures how much work is required to process an insurance claim work unit. Multiple weighted workloads can be added to indicate how much work is needed in aggregate to process a corresponding set of insurance claim work units. In the example below, a higher weighted workload indicates a greater amount of work. In other embodiments, the weighted workload can be implemented in such a way that a lower value indicates a greater amount of work.

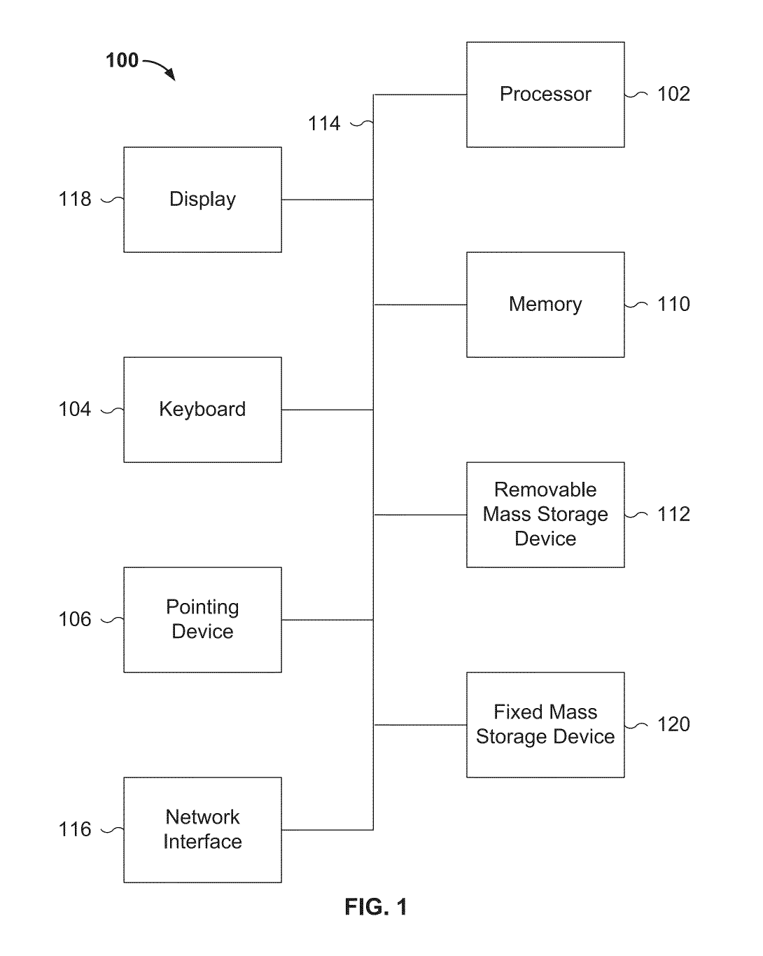

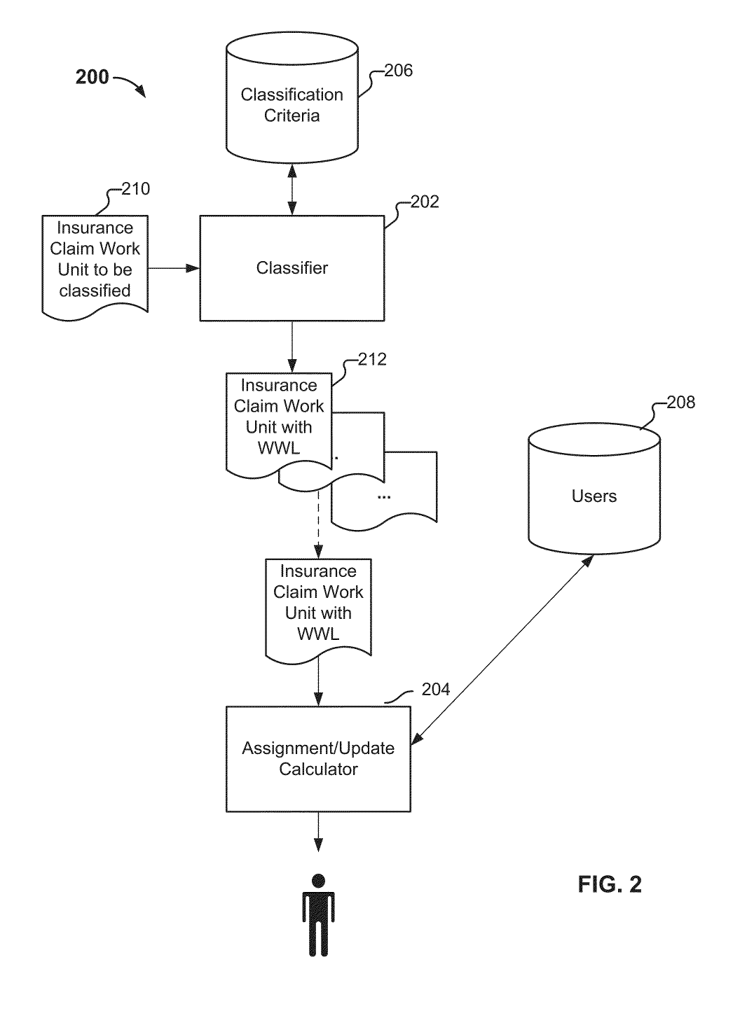

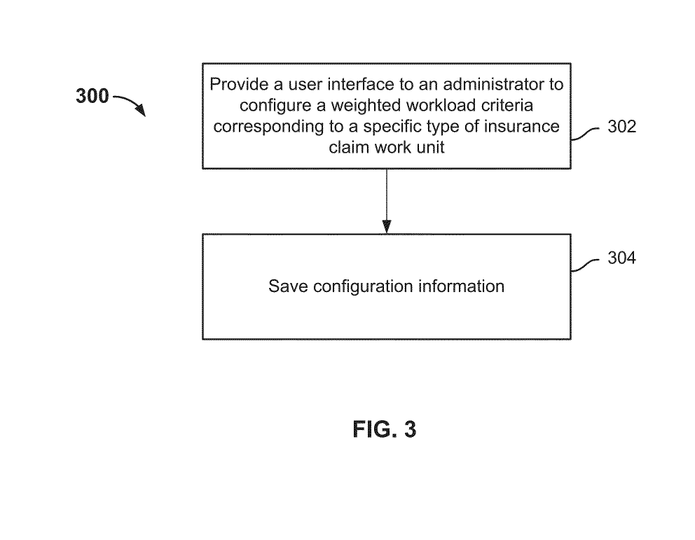

FIG. 1 is a functional diagram illustrating an embodiment of a programmed computer system for performing dynamic workload assignments in accordance with some embodiments. As will be apparent, other computer system architectures and configurations can be used to perform dynamic workload assignments in real-time. Computer system 100, which includes various subsystems as described below, includes at least one microprocessor subsystem (also referred to as a processor or a central processing unit (CPU)) 102. For example, processor 102 can be implemented by a single-chip processor or by multiple processors. In some embodiments, processor 102 is a general purpose digital processor that controls the operation of the computer system 100. Using instructions retrieved from memory 110, the processor 102 controls the reception and manipulation of input data, and the output and display of data on output devices (e.g., display 118). In some embodiments, processor 102 includes and/or is used to provide classifier 202 and assignment/update calculator 204 of FIG. 2 and/or executes/performs the processes and functions described below with respect to FIGS. 3-10.

Processor 102 is coupled bi-directionally with memory 110, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as is well known in the art, primary storage typically includes basic operating instructions, program code, data and objects used by the processor 102 to perform its functions (e.g., programmed instructions). For example, memory 110 can include any suitable computer-readable storage media, described below, depending on whether, for example, data access needs to be bi-directional or uni-directional. For example, processor 102 can also directly and very rapidly retrieve and store frequently needed data in a cache memory (not shown).

A removable mass storage device 112 provides additional data storage capacity for the computer system 100, and is coupled either bi-directionally (read/write) or uni-directionally (read only) to processor 102. For example, storage 112 can also include computer-readable media such as magnetic tape, flash memory, PC-CARDS, portable mass storage devices, holographic storage devices, and other storage devices. A fixed mass storage 120 can also, for example, provide additional data storage capacity. The most common example of mass storage 120 is a hard disk drive. Mass storage 112, 120 generally store additional programming instructions, data, and the like that typically are not in active use by the processor 102. It will be appreciated that the information retained within mass storage 112 and 120 can be incorporated, if needed, in standard fashion as part of memory 110 (e.g., RAM) as virtual memory.

In addition to providing processor 102 access to storage subsystems, bus 114 can also be used to provide access to other subsystems and devices. As shown, these can include a display monitor 118, a network interface 116, a keyboard 104, and a pointing device 106, as well as an auxiliary input/output device interface, a sound card, speakers, and other subsystems as needed. For example, the pointing device 106 can be a mouse, stylus, track ball, or tablet, and is useful for interacting with a graphical user interface.

The network interface 116 allows processor 102 to be coupled to another computer, computer network, or telecommunications network using a network connection as shown. For example, through the network interface 116, the processor 102 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Additional mass storage devices (not shown) can also be connected to processor 102 through network interface 116.

An auxiliary I/O device interface (not shown) can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

FIG. 2 is a functional diagram illustrating an embodiment of data structures and processing components of a dynamic insurance claim work unit assignment system. In this example, system 200 includes a classifier 202 providing a user interface for configuring classification criteria used to facilitate the computation of weighted workloads of insurance claim work units. A set of classification criteria specify a set of filtering criteria (e.g., a mapping of certain properties and corresponding values) and a classified workload associated with any insurance claim work unit that match the set of filtering criteria. Classification criteria configured by the authorized administrator are maintained in a data store 206.

In this example, an insurance claim work unit is generated by other parts of the platform, such as by a separate process that generates claims and divides them into insurance claim work units (not shown). For a given insurance claim work unit 210, the classifier identifies a set of matching classification criteria and applies the criteria to compute a weighted workload for the insurance claim work unit. In some embodiments, the classifier further provides user interfaces or automated methods to adjust the weighted workload value. The insurance claim work unit and its corresponding weighted workload are stored in a work unit data store 212. In some embodiments, the weighted workload values are updated as appropriate, such as when the statuses of the work units change or when certain events occur.

System 200 further includes a user data store 208 that stores user information, including user identifiers, and assignments of the insurance claim work units and the corresponding users handling the work units. In this example, users include claim adjusters who will perform work on the insurance claim work units and ultimately resolve the claims. In some embodiments, the user information is organized hierarchically.

System 200 further includes an assignment/update calculator 204 providing a user interface configured for the user to select a specific insurance claim work unit from the work unit data store and assign the specific insurance claim work unit to a user. Based on user information and the requirements of insurance claim work unit to be assigned, a set of eligible users are selected. The weighted workload of work units handled by each eligible user is computed and adjusted as appropriate. A set of one or more assignment rules are applied based on the adjusted weighted workloads to select an appropriate user to process the insurance claim work unit. Once the administrator assigns the insurance claim work unit to the selected user, user information data store 208 is updated with the assignment information.

In the embodiment shown, system 200 can be implemented using one or more systems such as 100 of FIG. 1. Classifier 202 and assignment/update calculator 204 can be implemented using one or more processors such as 102. Storages 206 and 208 can be memory 110, local storage devices 112 or 120, or a network storage (not shown) implementing a table, a list, a database, or any other appropriate data structures.

FIG. 3 is a flowchart illustrating an embodiment of a process for configuring the weighted workload classification criteria. In some embodiments, process 300 may be performed by a system such as 100 or 200.

At 302, a user interface is provided to an administrator (e.g., a manager) to configure a set of weighted workload classification criteria corresponding to a specific type of insurance claim work unit. The weighted workload classification criteria map the specific type of insurance claim work unit to a classified weighted workload. At 304, the configuration information entered by the administrator is saved (e.g., to data store 206 of FIG. 2).

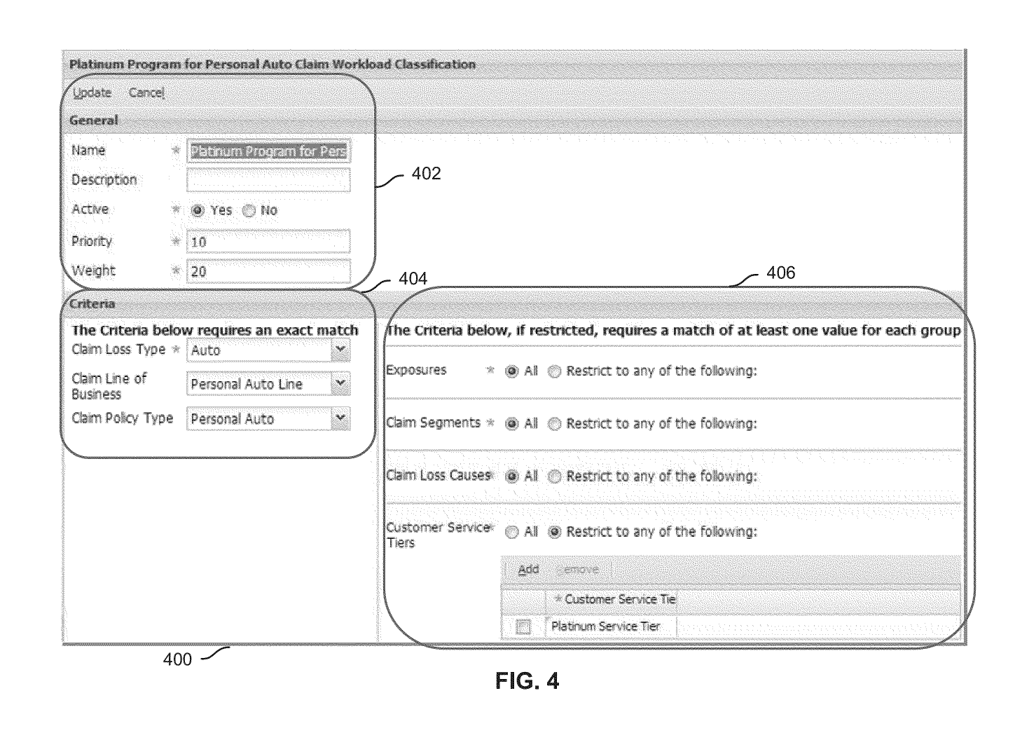

FIG. 4 is an embodiment of a classification configuration user interface screen used to configure a set of weighted workload classification criteria of a specific type of insurance claim work unit. In some embodiments, the interface is provided to an administrator who is given special permission to access the configuration tool. The interface is used to configure a set of weighted workload classification criteria and a corresponding classified weighted workload, such that an insurance claim work unit matching the set of weighted workload classification criteria is assigned the classified weighted workload.

Area 402 of the user interface screen includes a set of basic information. Fields are provided for the administrator to enter a name for the insurance claim work unit, a description, and whether this classification for the insurance claim work unit is active. Additional fields include a classified weight and a priority. The classified weight is the base weight to be assigned to any insurance claim work unit that matches the set of criteria, and reflects the average complexity/work needed to process this type of insurance claim work unit. The priority is used for tie breaking purposes; in particular, if an insurance claim work unit matches multiple sets of classification criteria, the work unit is assigned the classified weight that corresponds to the set of classification criteria with the highest priority. In some embodiments, the priority is implemented using a score where a greater priority score indicates a higher level of priority and overrides a score with a lesser priority score. In some embodiments, the priority is implemented using a rank where a smaller ranking number indicates a higher level of priority and overrides a rank with a greater ranking number.

Specific matching or filtering criteria are specified in areas 404 and 406. The first level criteria area 404 includes fields that must be matched exactly by the insurance claim work unit. In this example, the fields include claim loss type (e.g., automobile, building, injury, etc.), claim line of business (e.g., personal auto line, business line, home owner's line, etc.), and claim policy type (e.g., personal auto, home owners, worker's compensation, etc.) The second level criteria 406 includes fields that can have more than one value for matching purposes. As shown, a field can be set as restricted or unrestricted. If “all” is selected for a field, then the field is unrestricted (in other words, does not impose further restrictions and any value will be considered a match). If “restrict to any of the following” is selected, then the administrator is given the option to select among possible values ones that act as filtering criteria, specify a particular value, or both. An insurance claim work unit can match any of the values and be considered to have matched the field. In the example shown, restrictions can be imposed based on claim exposure (which corresponds to measurements of how much potential loss the claim may face, such as “less than $500”, “$500-$2000”, “greater than $2000”, etc., claim segment (which corresponds to logical grouping of claims based on the type of adjuster who will work on the claim, such as “complex third party injury”, etc.), claim loss cause (which corresponds to what caused the claim, such as “theft”, “accident”, etc.), customer service tier (which corresponds to the level of service a particular insured receives, such as “platinum service tier”, “gold service tier”, etc.). As shown, the administrator has not imposed any restrictions on exposure, claim segment, or claim loss cause, but has restricted customer service tiers to “platinum service tier” (thus excluding other customer service tiers such as “gold service tier” and “silver service tier.”) Accordingly, an insurance claim work unit that meets the first level criteria and whose customer service tier is “platinum service tier” will be assigned a classified weight of 20, with a priority rank of 10. As another example (not shown in figure), the administrator may select “restrict to any of the following” for “claim loss cause”, and specify that “theft of audio” and “theft of the entire vehicle” as possible matching values but exclude “collision with motor vehicle” as a matching value.

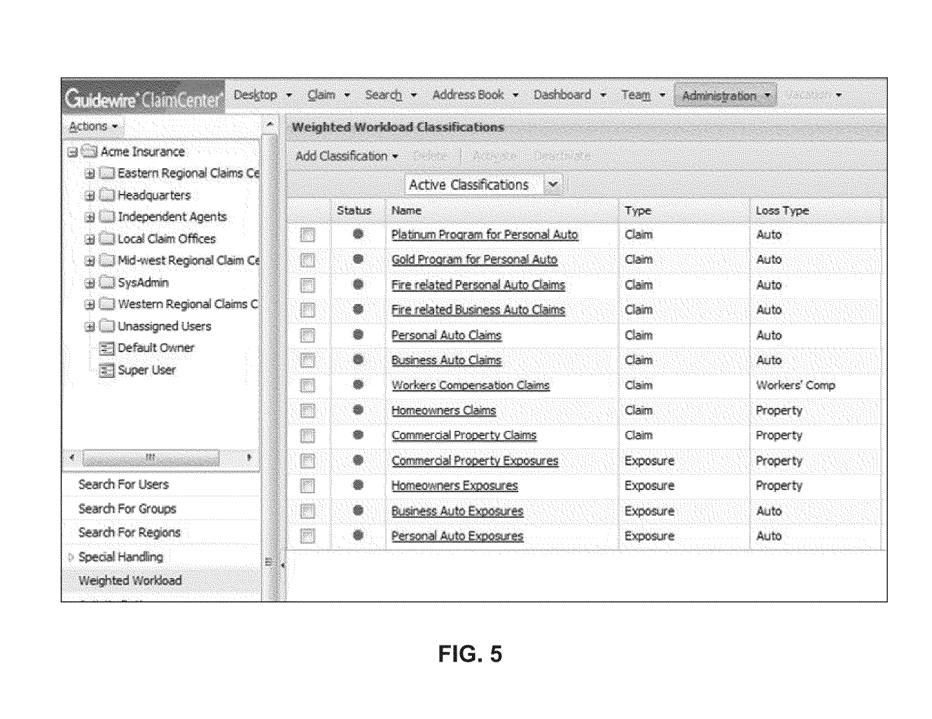

The configured classification criteria are stored and made available for administrator viewing and editing. FIG. 5 is an embodiment of a user interface screen illustrating a list of the classification criteria sets. An administrator can click on a classification criteria set and view details.

In some embodiments, a supplemental weight is used to adjust the weight of an individual insurance claim work unit in order to better reflect the difficulty associated with the work unit. The classification weight and the supplemental weight are summed to give the total weight, which is the true reflection of how much work an insurance claim work unit involves. The default value of the supplemental weight for an insurance claim work unit is 0. In some embodiments, an administrator is provided with a user interface to optionally configure a supplemental weight for each assignable insurance claim work unit. For example, if the administrator deems a claim involving an automobile collision to be easier to handle than average, the administrator can adjust the weighted workload of the claim by setting the supplemental weight to a negative value. In some embodiments, the system automatically assigns different supplemental weight to an insurance claim work unit during different stages of the unit's life cycle. For example, a positive supplemental weight is added to a claim when it is first created because typically more work is involved at this stage, and once the first contact with the insured is made, the supplemental weight is reset to 0. In some embodiments, multiple types of supplemental weights are available, such as an administrator-configured supplemental weight and a claim stage-related supplemental weight.

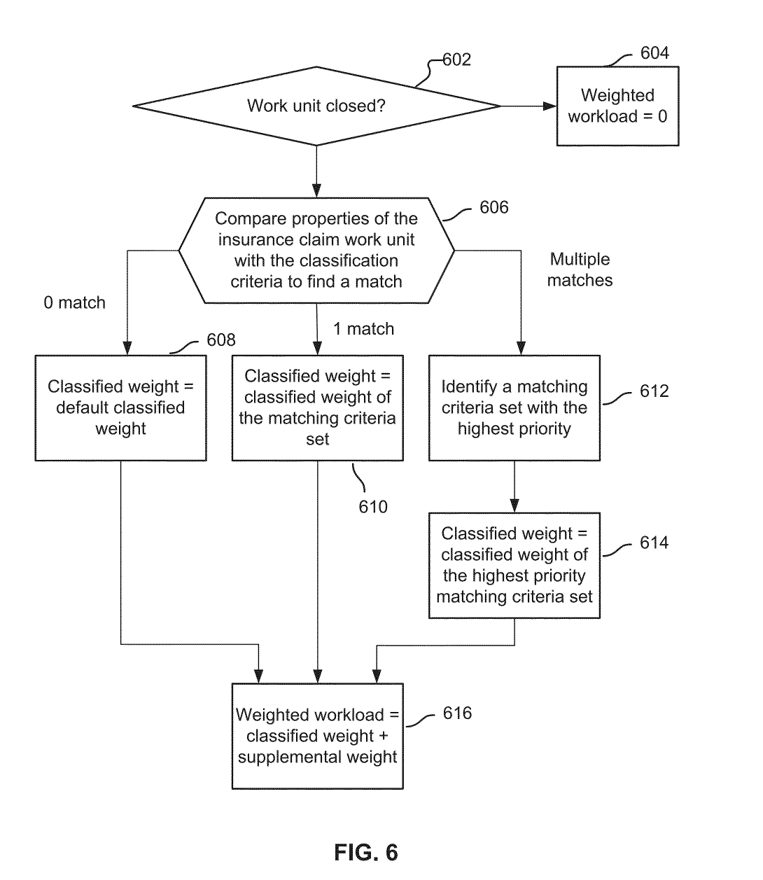

FIG. 6 is a flowchart illustrating an embodiment of a process for computing an insurance claim work unit's weighted workload. Process 600 may be performed on a system such as 100 and/or by classifier 202 of FIG. 2. In this example, the process takes place after the classification criteria sets used to classify the insurance claim work units and the supplemental weight of an individual insurance claim work unit are configured.

At 602, it is determined whether the insurance claim work unit is closed. If so, at 604, the insurance claim work unit is assigned a weighted workload of 0. In some embodiments, a closed insurance claim work unit retains its weight for reporting purposes, but this retained weight is not included in the calculation of a user's aggregated weight. If the insurance claim work unit is not closed, at 606, properties of the insurance claim work unit are compared with the classification criteria to find a match. For example, the claim's loss type, line of business, policy type, exposures, segments, claim loss cause, customer service tier, etc., are compared with classification criteria sets previously configured. If no match is found, at 608, a predefined default classified weight is assigned to the insurance claim work unit as the classified weight. If a single match is found, at 610, the classified weight of the matching classification criteria set is assigned to the insurance claim work unit as the classified weight. If multiple matches are found, at 612, the priorities of the matching classification criteria sets are compared to identify the one with the highest priority. The classified weight of the highest priority classification criteria set is assigned to the insurance claim work unit as the classified weight. In some cases, if there are multiple matching sets with the same priority, a selection rule is used to break the tie, such as making a random selection, making a selection of the highest or lowest weight, etc. In some implementation, at the database level, different fields are given unique priority levels and therefore the priority of each classification criteria set is unique. At 614, the classified weight of the highest priority classification criteria set (or the criteria set selected by the tie-breaking selection rule) is assigned to the insurance claim work unit as the weighted workload.

Use the classification criteria configured in FIG. 4 as an example, the open/closed state of an insurance claim work unit is first determined, and if the state is open, then the claim loss type, claim line of business, claim policy type, and customer service tier associated with the insurance claim work unit are compared with the classification criteria to determine whether there is a match. The same insurance claim work unit can also match multiple criteria sets, the criteria set with the highest priority level (e.g., the highest priority score or the lowest priority rank depending on implementation) will override other priority sets, and the insurance claim work unit would receive the classification weight that corresponds to the criteria set with the highest priority level. In the example shown, an insurance claim work unit that matches criteria set 400 will receive a classification weight of 20 unless criteria set 400 is overridden by another classification criteria set with a higher priority level.

Returning to process 600, at 616, the resulting classified weight and the supplemental weight are added to generate the weighted workload of the insurance claim work unit.

In this example, a decision on how to assign a weighted workload is based on whether the work unit is open or closed. In some embodiments, other/additional states can result in different formulas for weighted workload computation being applied. In some embodiments, the supplemental weight can change for different stages of an open claim (e.g., the supplemental weight is 10 after the first contact with the insured is made, then changed to 5 when after the first payment is made), and thus different weighted workloads can result depending on the claim state.

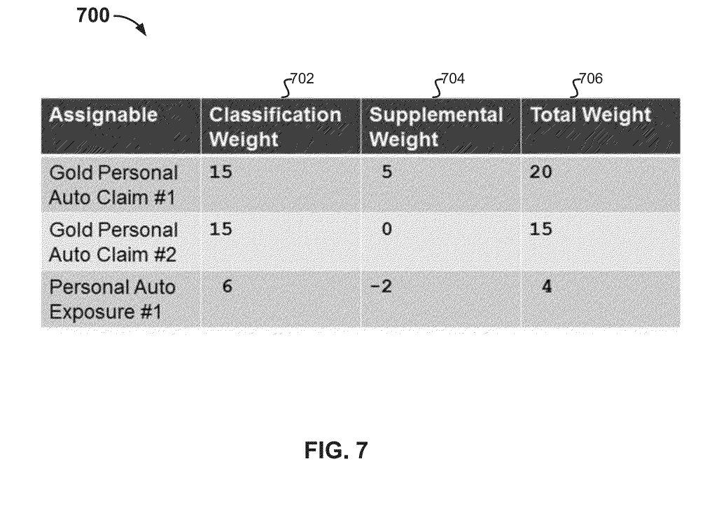

FIG. 7 is an embodiment of a user interface illustrating a table of insurance claim work units (assignables) and their respective weights. Table 700 provides an overview of active insurance claim work units that are currently being processed. Each row represents a specific insurance claim work unit. Column 702 shows the classified weight of each insurance claim work unit. Column 704 shows the supplemental weight. Column 706 shows the total weight. A user with an appropriate level of permission can view the breakdown of the work unit's classification weight and supplemental weight, and edit the supplemental weight as appropriate.

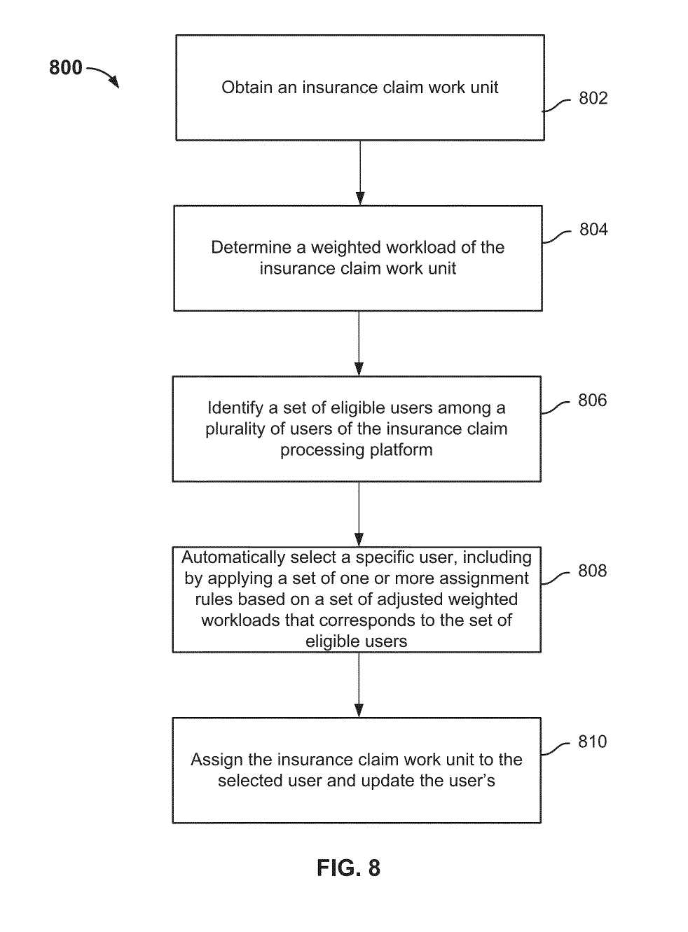

FIG. 8 is a flowchart illustrating an embodiment of a process for dynamically assigning an insurance claim work unit. In some embodiments, process 800 is implemented by a system such as 100 or 200 on an insurance claims processing platform.

At 802, an insurance claim work unit is obtained. In some embodiments, insurance claim work units are created as new claims are generated on the insurance claims processing platform. In some cases, an administrator can manually select an insurance claim work unit that is available to be assigned. In some cases, unassigned insurance claim work units are automatically selected for assignment either as they are generated or during a batch process.

At 804, a weighted workload of the insurance claim work unit is determined. In some embodiments, the weighted workload is pre-computed (using a process such as 600) and the determination includes selecting the pre-computed value. In some embodiments, the determination includes performing a computation process such as 600.

At 806, a set of eligible users among a plurality of users (e.g., claim adjusters) of the insurance claims processing platform is identified. In some embodiments, user information is stored in a searchable form, and selection rules are applied to identify the eligible users whose characteristics match the properties/requirements of the insurance claim work unit.

At 808, a specific user is automatically selected among the set of eligible users. As will be described in greater detail below, in some embodiments, the selection includes applying one or more assignment rules based on a set of adjusted weighted workloads that correspond to the eligible users. In some embodiments, the assignment rule specifies that the insurance claim work unit is assigned to an eligible user with the least adjusted weighted workload. Other assignment rules, such as round robin assignment, can be used.

At 810, the insurance claim work unit is assigned to the selected user, and the assignment information (e.g., the user's group weighted workload and adjusted weighted workload) is updated.

In some embodiments, the particular weight of an insurance claim work unit does not necessarily affect who is assigned the work unit. Thus, 804 may occur after 810 (in other words, the insurance claim work unit is assigned first. Subsequently, the weight of the insurance claim work unit is determined, and workload is updated for the selected user to whom the insurance claim work unit is assigned.)

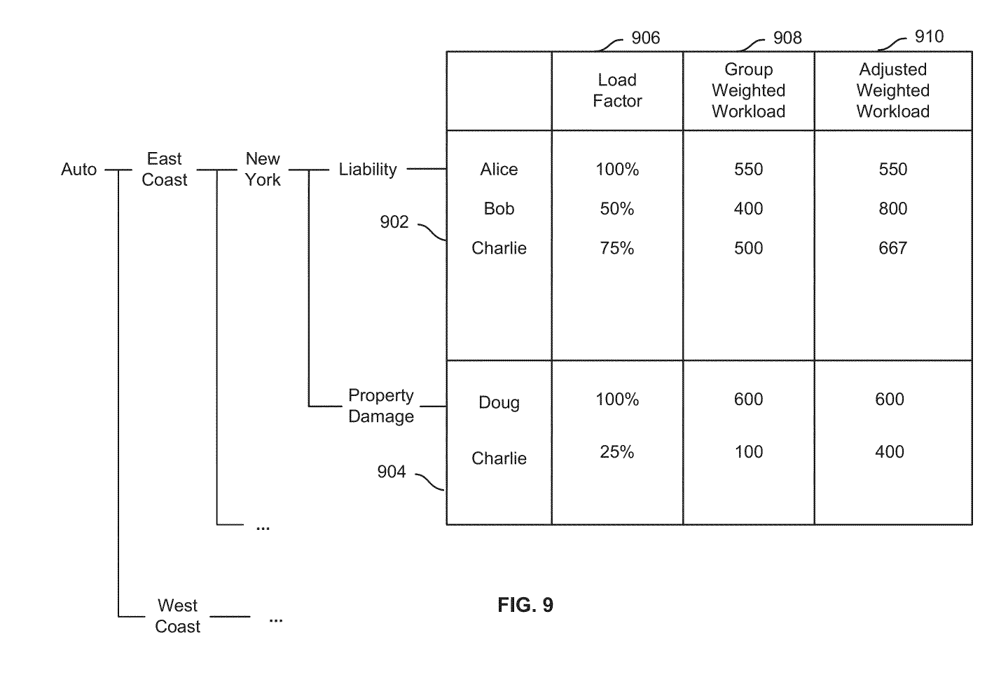

Identifying eligible users and selecting the specific user are discussed in connection with FIG. 9. FIG. 9 is a data structure diagram illustrating an embodiment of an organizational hierarchy. In this example, users are organized into an organizational hierarchy that is used to facilitate the identification of eligible users. Specifically, users are organized hierarchically according to lines of business (e.g., automobile, homeowner, etc.), geography (e.g., East Coast, West Coast, states, etc.), and specialty groups (e.g., liability, property damage, etc.). To identify eligible users for an insurance claim work unit, certain rules are applied to the organizational hierarchy and users whose characteristics conform to the properties/requirements of the insurance claim work unit are identified. In this example, eligible users are the users within a matching geographical region and a specialty group specializing in handling the particular type of claim. For example, if an insurance claim work unit involves an automobile accident that occurred in New York and that involves liability, users in the specialty group 902 are identified as the eligible users. Other organizations and identification techniques can be used in other embodiments. For example, additional attributes can be associated with the users, such as vacation status, special skills (e.g., speaks certain language), etc. Additional filtering rules may be applied with respect to these attributes to select as eligible users those who are not currently on vacation, who can speak Spanish, etc.

A user can belong to more than one group or work only part time for a single group, and his work commitment to each group that he belongs is indicated by a load factor (column 906). The default value of a load factor is 100%. As shown, in the liability group, Alice's load factor is 100%, indicating that she works full time for the group; Bob's load factor is 50%, indicating that he works half time for the group, and Charlie's load factor is 75%, indicating that he works 75% of the time for this group. In the property damage specialty group, Doug's load factor is 100%; and Charlie, who also works for this group part time, has a load factor of 25%.

The group weighted workload (column 908) of each user in a particular group is computed by adding the total weighted workload of all work units handled by the user for that group. The group weighted workload is divided by the load factor to generate the adjusted weighted workload (column 910), which is a more realistic reflection of how busy a user is given his committed load with respect to that group. For example, if adjusters in the liability specialty group in New York are selected as the set of eligible users, then, based on a comparison of the adjusted weighted workloads, Alice, who has an adjusted weighted workload of 550, would be assigned the next insurance claim work unit. In this example, even though on an absolute scale Charlie has the least weighted workload of 500 in the group, his adjusted weighted workload is 667, which is higher than Alice's adjusted weighted workload.

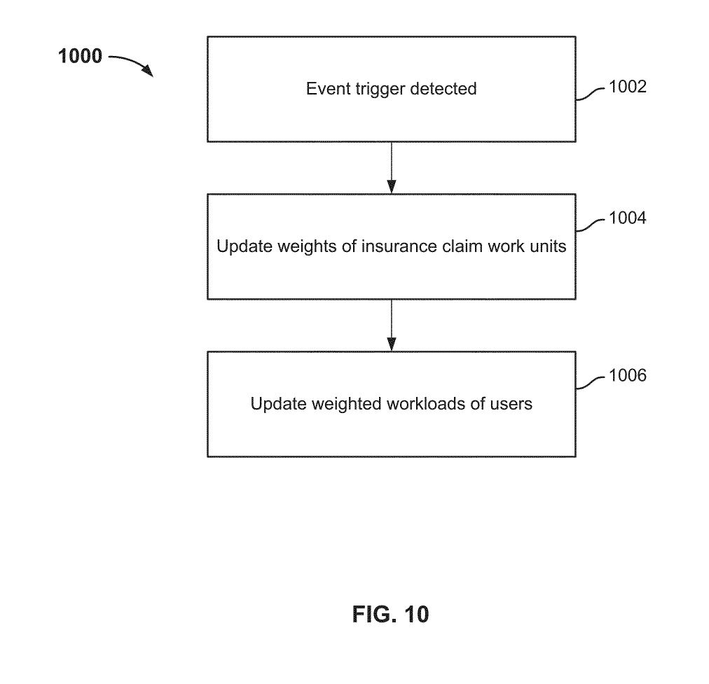

In some embodiments, the weighted workloads (including the group weighted workloads and/or the adjusted weighted workloads) of users on the claim processing platform are updated dynamically in real-time to ensure that assignments are fairly made. FIG. 10 is a flowchart illustrating an embodiment of an update process. Process 1000 can be performed on a system such as 100 or 200.

At 1002, an event trigger is detected. In this example, the system monitors changes to the insurance claim work units and detects event triggers whenever significant changes occur that affect the weighted workload of an insurance claim work unit. Examples of events that trigger changes include: an insurance claim work unit is closed, an insurance claim work unit is reopened, a new insurance claim work unit is created, an existing insurance claim work unit is reassigned, a claim gains or loses an exposure, the supplemental weight of an insurance claim work unit is created or modified, etc. In some embodiments, certain change rules are preconfigured to detect the events that trigger changes, as well as to specify the change to the classified weight or the supplemental weight. For example, the detection can be implemented as code that is invoked in response to a specific change to a claim work unit, such as a function to create the claim work unit, a function to change its assignment, etc.

At 1004, the weighted workload of an insurance claim work unit affected by the event is updated. In some embodiments, process 600 of FIG. 6 is invoked to compute the weighted workloads of the insurance claim work unit.

At 1006, the weighted workloads of an affected user are updated. In some embodiments, the user who has been assigned the insurance claim work unit is identified. The identified user's group weighted workload is recomputed by adding the most up-to-date weighted workloads of the work units handled by this user, and the adjusted weight workload for the user is recomputed by dividing the updated group weighted workload by the user's current load factor.

In some embodiments, process 1000 is repeated to keep the adjusted weighted workloads of users up-to-date and permit fair assignment based on the most current adjusted weighted workloads.

Dynamically assigning insurance claim work to users on an insurance claims processing platform is disclosed. By using weighted workload that account for complexity and work commitment, assignments can be made automatically and fairly amongst the users.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for assigning insurance claim work on an insurance claims processing platform, comprising:
one or more computer processors configured to:
obtain an insurance claim work unit;
identify among a plurality of users of the insurance claims processing platform a set of eligible users who are eligible to process the insurance claim work unit; and
automatically select among the set of eligible users a selected user to process the insurance claim work unit, including determining a set of weighted workloads that corresponds to the set of eligible users and applying a set of one or more assignment rules based on the set of weighted workloads; and
one or more memories coupled to the one or more computer processors, configured to provide the one or more computer processors with instructions.

2. The system of claim 1, wherein the one or more computer processors are further configured to:
provide a configuration interface used to configure a set of weighted workload classification criteria associated with a type of insurance claim work unit;
receive, via the configuration interface, an administrator configuration of the set of weighted workload classification criteria associated with a type of insurance claim work unit;
maintain the set of weighted workload classification criteria associated with a type of insurance claim work unit.

3. The system of claim 1, wherein the one or more computer processors are further configured to determine a weighted workload of the insurance claim work unit, wherein the weighted workload is calculated based at least in part on a set of weighted workload classification criteria.

4. The system of claim 3, wherein to determine the weighted workload of the insurance claim work unit includes to:
determine a classified weight that corresponds to the insurance claim work;
combine the classified weight and a supplemental weight to generate the weighted workload of the insurance claim work unit.

5. The system of claim 3, wherein the supplemental weight is manually assigned.

6. The system of claim 3, wherein the supplemental weight changes during different stages of a lifecycle of an insurance claim.

7. The system of claim 1, wherein:
the plurality of users are organized according to a user hierarchy;
to identify the set of eligible users includes to:
access the user hierarchy; and
identify the set of eligible users within the user hierarchy according to characteristics of the insurance claim work unit.

8. The system of claim 1, wherein a weighted workload that corresponds to a user includes an adjusted weighted workload that is determined based at least in part on a load factor indicating a user's commitment to a work group and a group weighted workload of the user.

9. The system of claim 1, wherein the one or more processors are further configured to dynamically update a weighted workload that corresponds to a user, including to:
detect an event trigger;
update the weighted workload of an insurance claim work unit that is affected by an event associated with the event trigger; and
update the weighted workload of the user who is assigned to handle the insurance claim work unit.

10. The system of claim 1, wherein the one or more processors are further configured to update assignment information associated with the selected user.

11. The system of claim 1, wherein the selected user is an eligible user with the least weighted workload.

12. A method of automated assignment of insurance claim work, comprising:
obtaining an insurance claim work unit;
identifying among a plurality of users of the insurance claims processing platform a set of eligible users who are eligible to process the insurance claim work unit; and
using one or more computer processors to automatically select among the set of eligible users a selected user to process the insurance claim work unit, including determining a set of weighted workloads that corresponds to the set of eligible users and applying a set of one or more assignment rules based on the set of weighted workloads.

13. The method of claim 12, further comprising:
providing a configuration interface used to configure a set of weighted workload classification criteria associated with a type of insurance claim work unit;
receiving, via the configuration interface, an administrator configuration of the set of weighted workload classification criteria associated with a type of insurance claim work unit;
maintaining the set of weighted workload classification criteria associated with a type of insurance claim work unit.

14. The method of claim 12, further comprising determining a weighted workload of the insurance claim work unit, wherein the weighted workload is calculated based at least in part on a set of weighted workload classification criteria.

15. The method of claim 14, wherein determining the weighted workload of the insurance claim work unit includes:
determining a classified weight that corresponds to the insurance claim work;
combining the classified weight and a supplemental weight to generate the weighted workload of the insurance claim work unit.

16. The method of claim 14, wherein the supplemental weight is manually assigned.

17. The method of claim 14, wherein the supplemental weight changes during different stages of a lifecycle of an insurance claim.

18. The method of claim 12, wherein:
the plurality of users are organized according to a user hierarchy;
identifying the set of eligible users includes:
accessing the user hierarchy; and
identifying the set of eligible users within the user hierarchy according to characteristics of the insurance claim work unit.

19. The method of claim 12, wherein a weighted workload that corresponds to a user includes an adjusted weighted workload that is determined based at least in part on a load factor indicating a user's commitment to a work group and a group weighted workload of the user.

20. The method of claim 12, further comprising dynamically updating a weighted workload that corresponds to a user, including:
detecting an event trigger;
updating the weighted workload of an insurance claim work unit that is affected by an event associated with the event trigger; and
updating the weighted workload of the user who is assigned to handle the insurance claim work unit.

21. The method of claim 12, further comprising updating assignment information associated with the selected user.

22. A computer program product for automated assignment of insurance claim work, the computer program product being embodied in a tangible computer readable storage medium and comprising computer instructions for:
obtaining an insurance claim work unit;
identifying among a plurality of users of the insurance claims processing platform a set of eligible users who are eligible to process the insurance claim work unit; and
automatically selecting among the set of eligible users a selected user to process the insurance claim work unit, including determining a set of weighted workloads that corresponds to the set of eligible users and applying a set of one or more assignment rules based on the set of weighted workloads.
